(19) United States
(12) Patent Application Publication
(10) Pub. No.: US 2009/0047638 A1
(43) Pub. Date: Feb. 19, 2009

(54) LEARNING SUPPORT METHOD AND SYSTEM

(75) Inventors: Nathen Jansen, Chilliwack (CA); Glenn Van Brempt, Zwijndrecht/Burcht (BE)

Correspondence Address: SUGHRUE MION, PLLC, 2100 PENNSYLVANIA AVENUE, N.W., SUITE 800, WASHINGTON, DC, 20037, US

(73) Assignee: NONA, Creative Consulting & Solutions Inc., CHILLIWACK (CA)

(21) Appl. No.: 11/838,441

(22) Filed: Aug. 14, 2007

(51) Int. Cl. G09B 19/00

(52) U.S. Cl. 434/127

(57) ABSTRACT

The present invention relates to a learning support method, in particular an Internet-based remote learning support method. This learning support method comprises the steps of determining a set of selection criteria for food preparation methods for preparing dishes or liquid drinks, said set of selection criteria comprising a proficiency level and at least one further selection criterion in the form of a diet selection, an ethnic or geographic origin selection and/or an ingredient selection; selecting a subset of food preparation methods responding to said set of selection criteria from among a stored set of food preparation methods; and presenting at least one food preparation method of said selected subset of food preparation methods. The invention also related to a learning support system for applying this method.

### BACKGROUND OF THE INVENTION

1. Field of the Invention

The present invention relates to a learning support method and system, in particular for supporting the learning of food preparation methods. By “food preparation method” should be understood, in the context of this specification, any method for preparing a food product, including liquid drinks.

2. Prior Art

In recent years, there has been an increase in popularity for home cooking, leading to a plethora of books, television programmes and Internet websites dedicated to teaching cooking recipes. These media address the interest of the public to, on one hand, recover the lost arts of home cooking and, on the other, learn exotic or “ethnic” recipes with which it has been recently confronted through travel or new food outlets in our increasingly multicultural societies.

In parallel, the rise of the Internet has generated a number of “e-learning”, that is, electronic distance learning, schemes in various areas, such as, for instance, language learning, which take advantage of the multimedia and interactive possibilities offered by the Internet and other data transmission networks to provide extensive and efficient learning support.

While cooking recipes and food preparation method explanations are already available in electronic form, the enhanced interactivity and flexibility of new media appears however to have been insufficiently exploited until now.

### SUMMARY OF THE INVENTION

An object of the present invention is to provide a learning support method and a learning support system that enable to present at least one food preparation method to a user according to his specific learning requirements and capabilities.

For the above object, according to a first aspect of the present invention, there is provided a learning support method, comprising the steps of:

determining a set of selection criteria for food preparation methods, said set of selection criteria comprising a proficiency level and at least one further selection criterion in the form of a diet selection, an ethnic or geographic origin selection and/or an ingredient selection;

selecting a subset of food preparation methods according to said set of selection criteria from among a stored set of food preparation methods; and

presenting at least one food preparation method of said selected subset of food preparation methods.

By determining a set of selection criteria comprising a proficiency level and at least one further selection criterion in the form of a diet selection, and ethnic or geographic origin selection and/or an ingredient selection, and then selecting a subset of food preparation methods according to this set of selection criteria, this learning support method enables the presentation of food preparation methods accurately adapted to the ability, taste and inclinations of the user.

Preferably, said at least one food preparation method is audiovisually presented. Such an audiovisual presentation, in particular in the form of a video clip, provides a more efficient and comfortable learning experience for the user, in particular for an activity such as food preparation where practical learning is much preferable to pure theory.

Preferably, said set of selection criteria is determined by a user input through a graphic user interface. Such graphic user interfaces provide a particularly intuitive means for user input and are readily available. However, alternative means for user input, such as, for example, voice recognition, could alternatively be considered.

Preferably, the learning support method of the invention may also comprise a step of presenting a preview of said selected subset of food preparation methods for an additional selection of the at least one food preparation method to be presented from among said selected subset of food preparation methods. This will enable a user to carry out a personal additional selection of at least one preferred food preparation method from among the selected subset of food preparation methods, in particular before being charged a presentation fee.

Preferably, the learning support method of the invention may also comprise a step of determining at least one timeframe in which said at least one food preparation method to be presented is to be presented. The at least one presentation may thus be scheduled in advance, following, for instance, a schedule or calendar determined by a user through such means as, for example, a graphic user interface.

Preferably, the learning support method of the invention may also comprise a step of presenting a list of ingredients for the at least one food preparation method to be presented. In this way, a user may receive, in visual, printed and/or audio form, a list of ingredients which could be used, for instance, as a shopping list before carrying out the at least one food preparation method to be presented.

Preferably, said set of selection criteria may also comprise a required food preparation skill. In this way, a user may select at least one food preparation method to be presented according to a specific food preparation skill, such as, for instance, roasting, filleting, poaching, frying, etc., which he may desire to practice.

Preferably, said set of selection criteria may also comprise a visual aspect of food. By “visual aspect of food” may be understood, for example, a dominant colour and/or a particular ornamentation scheme, enabling a user to select at least one food preparation scheme to be presented according to the visual aspect that he may desire to obtain for the dish, for instance for a more appealing presentation when receiving guests.

Preferably, said stored set of food preparation methods may be stored in a computer-readable data storage medium and the learning support method performed using at least one electronic data processing system. In this way, the learning support method of the invention may be carried out in a convenient, efficient and automated form.

Preferably, said stored set of food preparation methods may be stored at an electronic data server and the learning support method performed using said electronic data server and at least one electronic data processing system remotely connected to said electronic data server through an information network. In this way the learning support method of the invention may be carried out in a convenient, automated and particularly efficient remote form. In particular, said data transmission network may be a data transmission network using the TCP/IP data transmission protocol, such as the Internet, allowing the worldwide provision of the learning support method of the invention from a single electronic data server.

Preferably, said at least one food preparation method to be presented may be transmitted to an electronic data storage device, allowing for later retrieval. In particular, said electronic data storage device may be integrated into a portable unit, increasing the convenience for a user. Particularly advantageously, said portable unit may also comprise a visual and/or sound output interface, and said step of presenting said at least one food preparation method may be performed using said visual and/or sound output interface of said portable unit. Such a portable unit comprising an electronic data storage device and a visual and/or sound output interface may take the form, for instance, of a mobile phone, smartphone, PDA or a portable media device, such as an iPod®. This would allow a user to watch and/or listen to the presentation of at least one food preparation method at his or her entire convenience.

Another aspect of the invention relates to a learning support system comprising:

a data storage medium containing information over a set of food preparation methods; and

an electronic data processing system comprising:

data storage medium reading means for reading said information;

an input interface for entering a set of selection criteria for food preparation methods in said electronic data processing system, said set of selection criteria comprising a proficiency level and at least one further selection criterion in the form of a diet selection, an ethnic or geographic origin selection and/or an ingredient selection;

an electronic data processing device programmed to select, from said set of food preparation methods, a subset of food preparation methods according to said set of selection criteria; and

an output interface for presenting at least one of said selected subset of food preparation methods.

The invention will now be described in an illustrative, but not restrictive manner with reference to the drawings.

### BRIEF DESCRIPTION OF THE DRAWINGS

FIG. 1 illustrates a preferred embodiment of a learning support system according to the invention;

FIG. 2a illustrates a simplified graphic user interface for a first selection step of an embodiment of the method of the invention;

FIG. 2b illustrates an alternative graphic user interface for said first selection step;

FIG. 2c illustrates another alternative graphic user interface for said first selection step;

FIG. 3 illustrates a preview of a selected subset of food preparation methods;

FIG. 4 illustrates a presentation schedule for several food preparation methods to be presented; and

FIG. 5 illustrates a visual display presenting a food preparation method and an ingredient list for said food preparation method.

### DETAILED DESCRIPTION

The learning support method of the invention is preferably implemented using an information network such as the Internet. In that case, the learning support system of the invention may interact with a user through, for instance, a website.

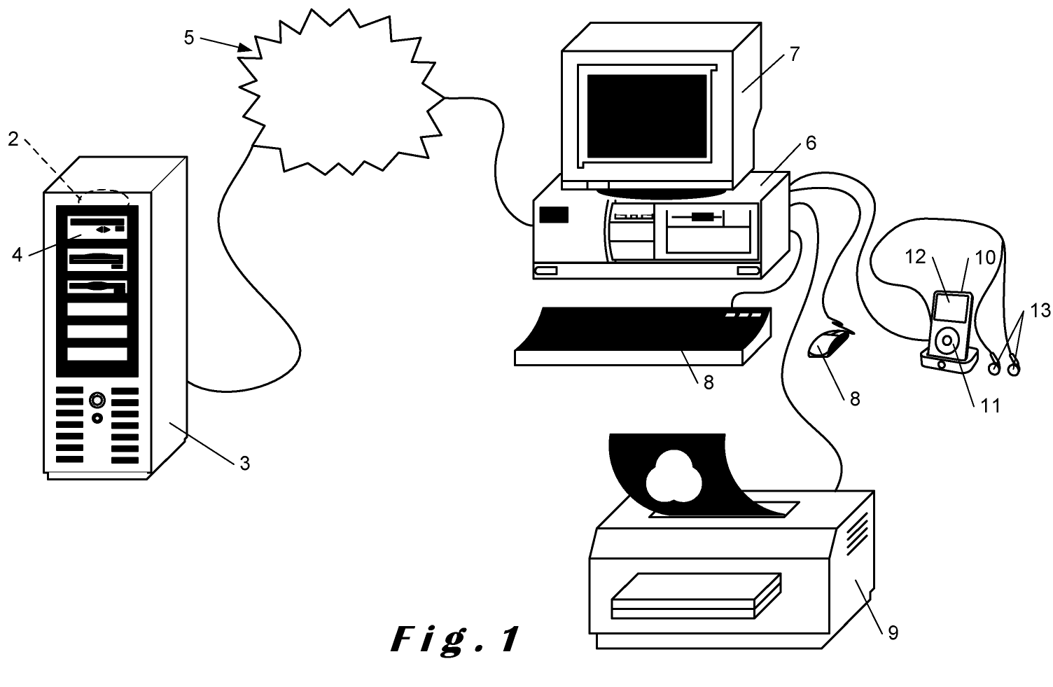

FIG. 1 shows a preferred embodiment of such a learning support system 1 according to the invention. In the illustrated learning support system 1, information over a set of food preparation methods is stored in the form of video clips of those food preparation methods in a data storage medium 2. This data storage medium 2 may be, for example, an optical, magnetic or electronic data storage medium, such as a read-only, recordable or rewritable optical disc, a hard disk, a magnetic tape, or a flash memory. This data storage medium 2 is installed in a data server 3 with data storage medium reading means 4. The data server 3 is connected over an information network 5, such as the Internet, with a computer 6 comprising a video display unit 7 and input means 8 and connected to a printer 9 and a portable media device 10, such as, for instance, an iPod®. The illustrated portable media device 10 comprises an electronic data storage device 11, a video display unit 12 and an audio output 13.

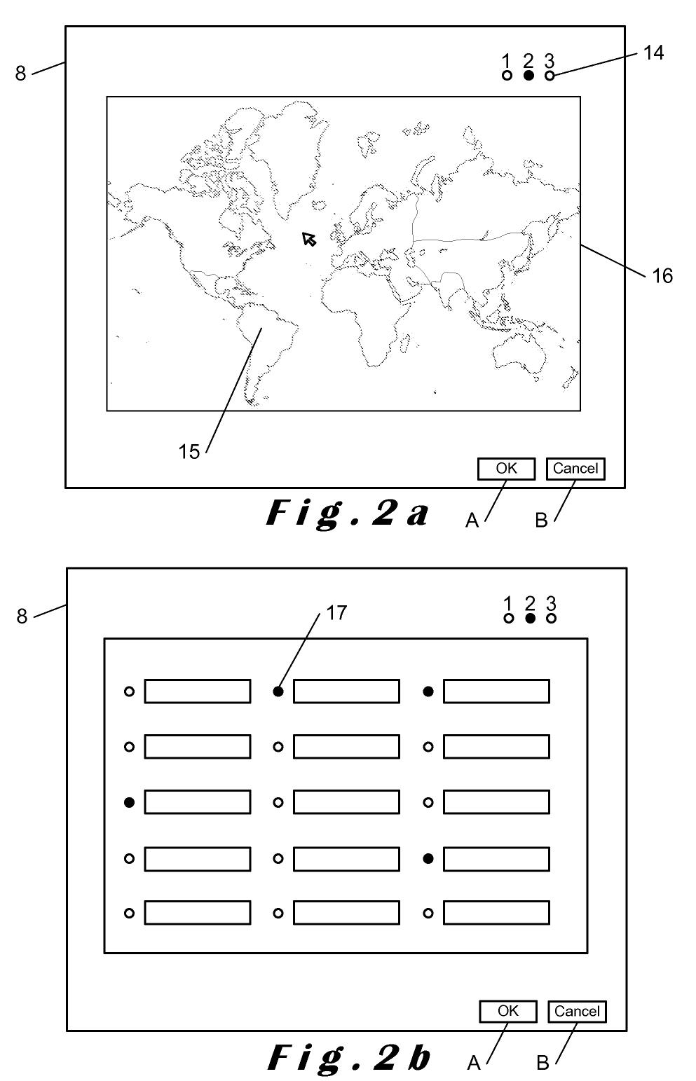

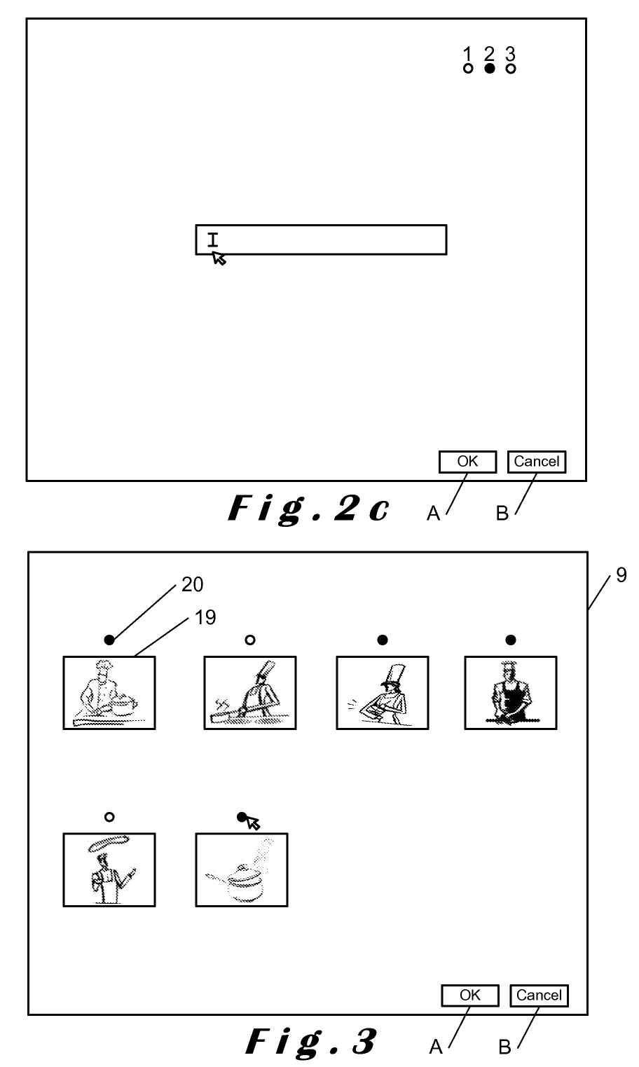

Connecting with the data server 3 through the computer 6 and the information network 5, a user will be presented in the video display unit 7 with a graphic user interface 8, such as those illustrated in FIG. 2a, 2b or 2c, in order to input a set of selection criteria according to which a subset of food preparation methods is going to be selected from among the set of food preparation methods. Instead of a graphic user interface, however, it should be understood that other input means, such as a voice interface, may be used instead for this purpose. Before being allowed access, the user may be required to log in with a particular user account, for instance to facilitate billing through a subscription or direct billing service.

In the graphic user interface 8 illustrated in FIG. 2a, the selection criteria are a proficiency level, selected, for example, by clicking on a proficiency level switch 14, and a further selection criterion in the form of an ethnic or geographic origin selection, corresponding to the origin of the dishes or drinks whose preparation methods are to be selected. This ethnic or geographic origin selection may be performed, for instance, by clicking on a particular region 15 in an interactive map 16. Alternatively or complementarily, a more conventional text input may be offered. The ethnic or geographic origin selection may be performed using multiple selection levels: if a particular region 15 is selected, the user may be presented with a further choice of sub-regions within that region 15. The selection may be confirmed by clicking on a confirmation button A, or cancelled by clicking on a cancellation button B.

Alternatively, as illustrated in FIG. 2b, the further selection criterion may be a dietary selection, wherein the user may choose or exclude certain diets for health, lifestyle or religious reasons, or because of simple personal preferences. This dietary selection may be performed for example by clicking on dietary selection switches 17 in the graphic user interface 8. Again, the selection may be confirmed by clicking on a confirmation button A, or cancelled by clicking on a cancellation button B.

In another alternative illustrated in FIG. 2c, the further selection criterion may be an ingredient selection. In this way a user could select the subset of food presentation methods according to the ingredients which he or she has available. Such an ingredient selection may be performed, for example, by entering the selected ingredients in a text box 18 in the graphic user interface 8. This proficiency level and ingredient selection may also be confirmed by clicking on a confirmation button A, or cancelled by clicking on a cancellation button B.

Of course, it is also possible to combine several of these further selection criteria in a single- or multi-level selection. An ethnic or geographic origin selection may, for instance, be followed by an ingredient or dietary selection, or viceversa. Also, other further selection criteria may be added, such as a required food preparation skill, enabling the user to select food preparation methods according to whether they include a step requiring a specific food preparation skill (frying, boiling, roasting, poaching, filleting, steaming, etc.) the user may wish to practice, or a visual aspect of food, allowing the user to select food preparation methods producing dishes or drinks having a certain visual aspect, such as a certain colour or a particular ornamentation.

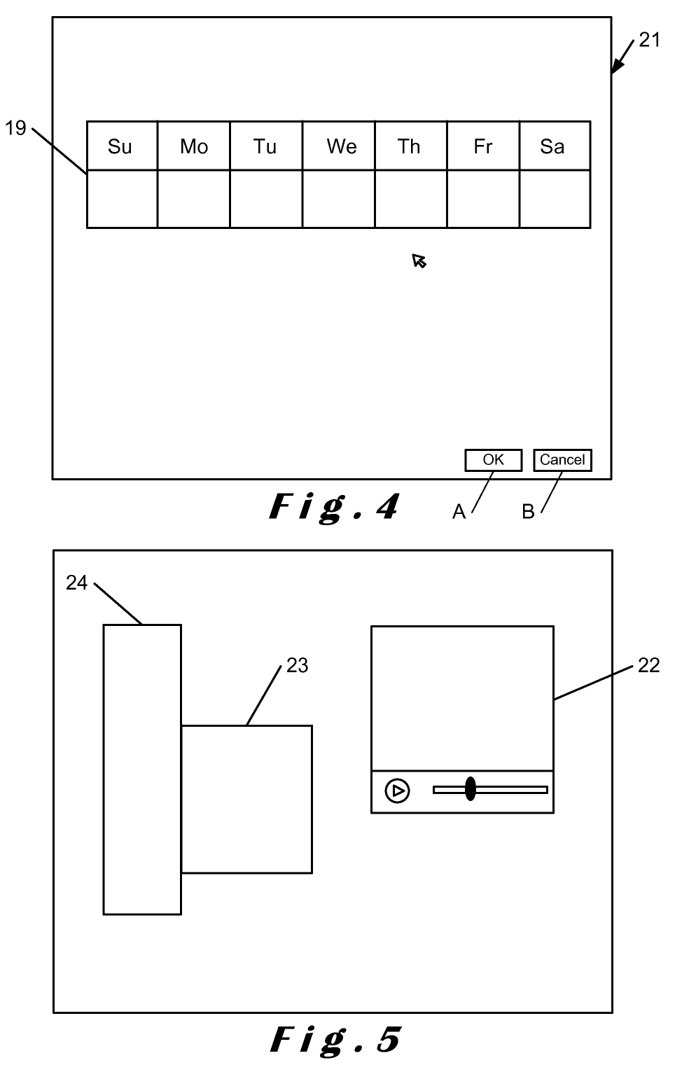

After the selection step is performed through the graphic user interface 8, the user may be presented, in the same video display unit 7, with a preview 9 of the selected subset of food preparation methods, as illustrated in FIG. 3. This preview 9 may for example be formed, as shown, by a series of pictures 19 representing the outcome (dish, drink) of each food preparation method. These pictures 19 may be replaced with or supplemented by, for instance, short video clips of parts of the corresponding food preparation methods. From this preview 9, the user may select one or several specific food preparation methods to be presented, for example by clicking on the corresponding pictures 19, or on associated selection switches 20. This further selection can also be confirmed or cancelled using, respectively, buttons A or B.

The user may also determine how those one or several specific food preparation methods are to be presented. He or she may choose to present them directly on the video display unit 7 of the computer 6, or to download them to the portable media device 10, where they are to be stored in the electronic data storage device 11 for later presentation using its video display unit 12 and/or audio output 13.

It is also possible to prepare a presentation schedule 21 for the food preparation methods to be presented, as illustrated in FIG. 4. In the illustrated presentation schedule 21, to be displayed in the video display unit 7 of computer 6, pictures 19 of the food presentation methods to be presented are arranged according to the day in which each food preparation method is going to be presented. They may be rearranged according to the user preferences using any input method known by the skilled person, such as dragging and dropping or direct text input. The schedule may also be confirmed or cancelled using, respectively, buttons A or B.

FIG. 5 illustrates how a food preparation method may be presented on the video display unit 7 of the computer 6. In a window 22, a video of the food presentation method may be shown, possibly accompanied by sound emitted through internal or external loudspeakers of headphones of the computer 6. A written explanation, or recipe, of the food preparation method may simultaneously be displayed in text window 23, while an ingredient list is displayed in another text window 24. Eventually, the user may choose to print the written explanation or recipe and/or the ingredient list. A printed ingredient list will be particularly useful as a shopping list for the ingredients.

The user may be charged a flat access or subscription rate, or he may be charged on a pay-per-view basis for each presented food presentation method. Eventual combinations of these billing schemes could also be considered, such as, for instance, a flat rate covering a predetermined maximum number of presentations for a given period, plus an extra charge for each presented food preparation method above that predetermined number. Additional revenue may be generated from advertising.

Although the present invention has been described with reference to specific exemplary embodiments, it will be evident that various modifications and changes may be made to these embodiments without departing from the broader scope and spirit of the invention as set forth in the claims. Accordingly, the description and drawings are to be regarded in an illustrative sense rather than a restrictive sense.

1. A learning support method, comprising the steps of:
determining a set of selection criteria for food preparation methods, said set of selection criteria comprising a proficiency level and at least one further selection criterion in the form of a diet selection, an ethnic or geographic origin selection and/or an ingredient selection;
selecting a subset of food preparation methods responding to said set of selection criteria from among a stored set of food preparation methods; and
presenting at least one food preparation method of said selected subset of food preparation methods.

2. A learning support method according to claim 1, wherein said at least one food preparation method is audiovisually presented.

3. A learning support method according to claim 1, wherein said set of selection criteria is determined by a user input through a graphic user interface.

4. A learning support method according to claim 1, also comprising a step of presenting a preview of said selected subset of food preparation methods for an additional selection of the at least one food preparation method to be presented from among said selected subset of food preparation methods.

5. A learning support method according to claim 1, also comprising a step of determining at least one timeframe in which said at least one food preparation method to be presented is to be presented.

6. A learning support method according to claim 1, also comprising a step of presenting a list of ingredients for the at least one food preparation method to be presented.

7. A learning support method according to claim 1, wherein said set of selection criteria also comprises a required food preparation skill.

8. A learning support method according to claim 1, wherein said set of selection criteria also comprises a visual aspect of food.

9. A learning support method according to claim 1, wherein said stored set of food preparation methods is stored in a computer-readable data storage medium and the learning support method is performed using at least one electronic data processing system.

10. A learning support method according to claim 1, wherein said stored set of food preparation methods is stored at an electronic data server and the learning support method is performed using said electronic data server and at least one electronic data processing system remotely connected to said electronic data server through a data transmission network.

11. A learning support method according to claim 10, wherein said data transmission network uses the TCP/IP data transmission protocol.

12. A learning support method according to claim 1, wherein said at least one food preparation method to be presented is transmitted to an electronic data storage device.

13. A learning support method according to claim 12, wherein said electronic data storage device is integrated into a portable unit.

14. A learning support method according to claim 13, wherein said portable unit also comprises a visual and/or sound output interface, and said step of presenting said at least one food preparation method is performed using said visual and/or sound output interface of said portable unit.

15. A learning support method according to claim 1, further comprising a step of charging a fee for said presentation of at least one food preparation method.

16. A learning support method according to claim 15, wherein said fee is debited from a user account.

17. A learning support method according to claim 15, wherein said fee comprises an individual fee for each presented food preparation method.

18. A learning support method according to claim 15, wherein said fee comprises a subscription fee.

19. A learning support system comprising:
a data storage medium containing information over a set of food preparation methods; and
an electronic data processing system comprising:
data storage medium reading means for reading said information;
an input interface for entering a set of selection criteria for food preparation methods in said electronic data processing system, said set of selection criteria comprising a proficiency level and at least one further selection criterion in the form of a diet selection, an ethnic or geographic origin selection and/or an ingredient selection;
an electronic data processing device programmed to select, from said set of food preparation methods, a subset of food preparation methods according to said set of selection criteria;
an output interface for presenting at least one of said selected subset of food preparation methods.

20. A learning support system according to claim 19, wherein said output interface is a visual and/or sound output interface.

21. A learning support system according to claim 19, wherein said input interface is a graphic user interface.

22. A learning support system according to claim 19, wherein said set of selection criteria also comprises a required food preparation skill.

23. A learning support system according to claim 19, wherein said set of selection criteria also comprises a visual aspect of food.

24. A learning support system according to claim 19, wherein said electronic data processing device and said input and/or output interfaces are connected over an information network.

25. A learning support system according to claim 24, wherein said information network is an information network suitable for the TCP/IP data transmission protocol.

26. A learning support system according to claim 19, wherein said electronic data processing system further comprises an electronic data storage device for storing said at least one food preparation method to be presented.

27. A learning support system according to claim 26, wherein said electronic data storage device and said output interface are integrated into a single portable unit.
